(19) United States
(12) Patent Application Publication
(10) Pub. No.: US 2021/0233477 A1
(43) Pub. Date: Jul. 29, 2021

(54) DISPLAY DRIVING CIRCUIT, METHOD OF DRIVING DISPLAY DRIVING CIRCUIT, DISPLAY PANEL, AND DISPLAY DEVICE

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Jinxiang LI, Beijing (CN); Yang WANG, Beijing (CN); Chunjie WANG, Beijing (CN); Xiaochen CUI, Beijing (CN); Chengyong HE, Beijing (CN); Xingming WANG, Beijing (CN)

(73) Assignees: CHONGQING BOE OPTOELECTRONICS TECHNOLOGY CO., LTD., Chongqing (CN); BOE TECHNOLOGY GROUP CO., LTD., Beijing (CN)

(21) Appl. No.: 17/042,668

(22) PCT Filed: Mar. 26, 2020
(86) PCT No.: PCT/CN2020/081399

§ 371 Date: Sep. 28, 2020

(30) Foreign Application Priority Data
Mar. 27, 2019 (CN) 201910237997.5

(51) Int. Cl. G09G 3/3291; G09G 3/3283

(52) U.S. Cl. CPC G09G 3/3291; G09G 2310/0262; G09G 3/3283

(57) ABSTRACT

A display driving circuit, a method of driving a display driving circuit, a display panel, and a display device are provided. The display driving circuit includes a compensation circuit and at least one pixel circuit electrically connected to the compensation circuit. The pixel circuit is configured to receive a data compensation signal and control a current magnitude of a driving current flowing through a light-emitting element according to the data compensation signal, so as to apply an operating voltage to a first terminal of the light-emitting element. The compensation circuit is configured to receive the operating voltage and a data voltage and adjust the data compensation signal according to a difference between the operating voltage and the data voltage.

The present application claims the priority of Chinese patent application No. 201910237997.5, filed on Mar. 27, 2019, the entire disclosure of which is incorporated herein by reference as part of the disclosure of this application.

### TECHNICAL FIELD

Embodiments of the present disclosure relate to a display driving circuit, a method of driving a display driving circuit, a display panel, and a display device.

### BACKGROUND

Organic light-emitting diode (OLED) display devices have been widely concerned by popularity due to advantages such as wide viewing angle, high contrast, fast response speed, higher luminous brightness and lower driving voltage compared to inorganic light-emitting display devices, and the like. Based on the above characteristics, the OLED may be applied to devices with display functions, such as mobile phones, monitors, notebook computers, digital cameras, instruments, etc.

Pixel circuits in the OLED display devices generally adopt a matrix driving method, which is divided into an active matrix (AM) driving method and a passive matrix (PM) driving method according to whether a switching element is provided in each pixel unit. Although the PMOLED has a simple process and low cost, it cannot satisfy the needs of high-resolution and large-size display due to shortcomings such as crosstalk, high power consumption, short lifetime, etc. In contrast, in the AMOLED, a group of thin film transistors and storage capacitors are integrated in the pixel circuit of each pixel unit. The thin film transistors and storage capacitors are under driving control, so that the current flowing through the OLED can be controlled to enable the OLED to emit light according to requirements. Compared with the PMOLED, the AMOLED requires smaller driving current, and has lower power consumption and longer lifetime, which may satisfy the needs of large-scale display with high resolution and multiple gray levels. Furthermore, the AMOLED has obvious advantages in terms of the viewing angle, color restoration, power consumption, response time, etc., and may be applied to display devices with high information content and high resolution.

### SUMMARY

At least one embodiment of the present disclosure provides a display driving circuit, and the display driving circuit comprises a compensation circuit and at least one pixel circuit electrically connected to the compensation circuit. The pixel circuit is configured to receive a data compensation signal and control a current magnitude of a driving current flowing through a light-emitting element according to the data compensation signal, so as to apply an operating voltage to a first terminal of the light-emitting element; and the compensation circuit is configured to receive the operating voltage and a data voltage, and adjust the data compensation signal according to a difference between the operating voltage and the data voltage.

For example, in the display driving circuit provided by an embodiment of the present disclosure, the pixel circuit comprises a driving circuit, a data writing circuit, a storage circuit, and a detection circuit. The driving circuit comprises a control terminal and a first terminal, and is configured to control the current magnitude of the driving current according to the data compensation signal, and the first terminal of the driving circuit is connected to the first terminal of the light-emitting element; the data writing circuit is connected to the control terminal of the driving circuit, and is configured to write the data compensation signal into the control terminal of the driving circuit in response to a scanning signal; the storage circuit is connected to the control terminal of the driving circuit, and is configured to store the data compensation signal; and the detection circuit is connected to the first terminal of the light-emitting element, and is configured to transmit the operating voltage to the compensation circuit in response to the scanning signal.

For example, in the display driving circuit provided by an embodiment of the present disclosure, the compensation circuit comprises a comparison circuit and an integration circuit. The comparison circuit comprises an output terminal, and is configured to generate a feedback signal according to the difference between the operating voltage and the data voltage; and the integration circuit is connected to the output terminal of the comparison circuit, and is configured to perform an integration calculation on the feedback signal and generate the data compensation signal.

For example, in the display driving circuit provided by an embodiment of the present disclosure, the driving circuit comprises a first transistor, a gate electrode of the first transistor serves as the control terminal of the driving circuit, a first electrode of the first transistor is connected to a first voltage terminal, and a second electrode of the first transistor serves as the first terminal of the driving circuit.

For example, in the display driving circuit provided by an embodiment of the present disclosure, the data writing circuit comprises a second transistor, a gate electrode of the second transistor is connected to a scanning line to receive the scanning signal, a first electrode of the second transistor is connected to the compensation circuit to receive the data compensation signal, and a second electrode of the second transistor is connected to the control terminal of the driving circuit.

For example, in the display driving circuit provided by an embodiment of the present disclosure, the storage circuit comprises a first capacitor, a first electrode of the first capacitor is connected to a first voltage terminal, and a second electrode of the first capacitor is connected to the control terminal of the driving circuit.

For example, in the display driving circuit provided by an embodiment of the present disclosure, the detection circuit comprises a third transistor, a gate electrode of the third transistor is connected to a scanning line to receive the scanning signal, a first electrode of the third transistor is connected to the first terminal of the light-emitting element, and a second electrode of the third transistor is connected to the compensation circuit to transmit the operating voltage.

For example, in the display driving circuit provided by an embodiment of the present disclosure, the comparison circuit comprises a first operational amplifier and a feedback resistor. The first operational amplifier comprises a first input terminal, a second input terminal, and an output terminal, the first input terminal of the first operational amplifier is connected to a data line to receive the data voltage, the second input terminal of the first operational amplifier is connected to the pixel circuit to receive the operating voltage, and the output terminal of the first operational amplifier serves as the output terminal of the comparison circuit and is connected to the integration circuit; and a first terminal of the feedback resistor is connected to the second input terminal of the first operational amplifier, and a second terminal of the feedback resistor is connected to the first input terminal of the first operational amplifier.

For example, in the display driving circuit provided by an embodiment of the present disclosure, the feedback signal is expressed as: Vfb=If×Rfb×G1. Vfb represents the feedback signal, If represents a current generated between the pixel circuit and the comparison circuit due to the difference between the operating voltage and the data voltage, Rfb represents a resistance value of the feedback resistor, and G1 represents a magnification of the first operational amplifier.

For example, in the display driving circuit provided by an embodiment of the present disclosure, the integration circuit comprises a second operational amplifier, a first resistor, a second resistor, and a second capacitor. The second operational amplifier comprises a first input terminal, a second input terminal, and an output terminal, the first input terminal of the second operational amplifier is connected to a first terminal of the second resistor, the second input terminal of the second operational amplifier is connected to a first terminal of the first resistor, and the output terminal of the second operational amplifier is connected to the pixel circuit to output the data compensation signal; a second terminal of the first resistor is connected to the output terminal of the comparison circuit; a second terminal of the second resistor is connected to a second voltage terminal; and a first electrode of the second capacitor is connected to the output terminal of the second operational amplifier, and a second electrode of the second capacitor is connected to the second input terminal of the second operational amplifier.

For example, in the display driving circuit provided by an embodiment of the present disclosure, the data compensation signal is expressed as:

$$Vout ( t 2 ) = - \frac{1}{R 1 C} {\int }_{t 1}^{t 2} Vfb \times dt + Vout ( t 1 ) . Vout ( t 2 )$$

represents a data compensation signal at time t2, Vout(t1) represents a data compensation signal at time t1, R1 represents a resistance value of the first resistor, C represents a capacitance value of the second capacitor, and Vfb represents the feedback signal.

For example, in the display driving circuit provided by an embodiment of the present disclosure, the compensation circuit is further configured to receive the operating voltage and the data voltage and adjust the data compensation signal according to the difference between the operating voltage and the data voltage, so as to allow the operating voltage to be equal to the data voltage.

At least one embodiment of the present disclosure further provides a display panel which comprises a plurality of display driving circuits according to any one of the embodiments of the present disclosure and an array substrate. The array substrate comprises a pixel array region, and the pixel array region comprises a plurality of sub-pixels arranged in an array; and pixel circuits of the plurality of display driving circuits are respectively provided in the plurality of sub-pixels in the pixel array region of the array substrate, and compensation circuits of the display driving circuits are outside the pixel array region.

For example, the display panel provided by an embodiment of the present disclosure further comprises a plurality of first transmitting lines and a plurality of second transmitting lines. Each of the plurality of display driving circuits corresponds to one first transmitting line and one second transmitting line, the first transmitting line is connected between a pixel circuit and a compensation circuit of a corresponding display driving circuit so as to transmit the data compensation signal, and the second transmitting line is connected between the pixel circuit and the compensation circuit of the corresponding display driving circuit so as to transmit the operating voltage.

For example, the display panel provided by an embodiment of the present disclosure further comprises a data driving circuit, and the compensation circuit is provided in the data driving circuit.

For example, the display panel provided by an embodiment of the present disclosure further comprises a data driving circuit. The array substrate further comprises a peripheral region outside the pixel array region, and the compensation circuit is provided in the peripheral region and is electrically connected to the data driving circuit.

At least one embodiment of the present disclosure further provides a display device, which comprises the display panel according to any one of the embodiments of the present disclosure.

At least one embodiment of the present disclosure further provides a method of driving the display driving circuit according to any one of the embodiments of the present disclosure. The method comprises: controlling the current magnitude of the driving current flowing through the light-emitting element according to the data compensation signal, so as to apply the operating voltage to the first terminal of the light-emitting element; and receiving the data voltage and adjusting the data compensation signal according to the difference between the operating voltage and the data voltage.

For example, in the method provided by an embodiment of the present disclosure, receiving the data voltage and adjusting the data compensation signal according to the difference between the operating voltage and the data voltage comprises: receiving the data voltage and adjusting the data compensation signal according to the difference between the operating voltage and the data voltage, so as to allow the operating voltage to be equal to the data voltage.

### BRIEF DESCRIPTION OF THE DRAWINGS

In order to clearly illustrate the technical solutions of the embodiments of the present disclosure, the drawings of the embodiments will be briefly described in the following. It is obvious that the described drawings are only related to some embodiments of the present disclosure and thus are not limitative to the present disclosure.

FIG. 1 is a schematic block diagram of a display driving circuit provided by some embodiments of the present disclosure;

FIG. 2 is a schematic block diagram of a pixel circuit of a display driving circuit provided by some embodiments of the present disclosure;

FIG. 3 is a schematic block diagram of a compensation circuit of a display driving circuit provided by some embodiments of the present disclosure;

FIG. 4 is a schematic block diagram of another display driving circuit provided by some embodiments of the present disclosure;

FIG. 5 is a circuit diagram of a specific implementation example of the display driving circuit illustrated in FIG. 4;

FIG. 6 is a circuit diagram of another specific implementation example of the display driving circuit illustrated in FIG. 4;

FIG. 7 is a signal timing diagram of a display driving circuit provided by some embodiments of the present disclosure;

FIG. 8 is a simulation flowchart of a display driving circuit provided by some embodiments of the present disclosure;

FIG. 9 is a schematic diagram of a simulation result of a display driving circuit provided by some embodiments of the present disclosure;

FIG. 10 is a schematic diagram of a display panel provided by some embodiments of the present disclosure;

FIG. 11 is a schematic diagram of another display panel provided by some embodiments of the present disclosure;

FIG. 12 is a schematic diagram of still another display panel provided by some embodiments of the present disclosure;

FIG. 13 is a schematic block diagram of a display device provided by some embodiments of the present disclosure; and

FIG. 14 is a schematic flowchart of a method of driving a display driving circuit provided by some embodiments of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect,” “connected,” “coupled,” etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The characteristic of the transistor in the pixel circuit is one of the main factors affecting the quality of the display image. The characteristics of the materials of the transistor are inconsistent in space and degenerated with time. There is threshold voltage shift of different forms whether in a transistor amorphous silicon or poly-silicon is adopted or in a transistor a metal oxide semiconductor is adopted. For example, when the display panel has a large size, the threshold voltages of the transistors at different positions have different degrees of shift, resulting in poor uniformity of the display panel. For another example, after a transistor is used for a period of time, the gate electrode of the transistor is always biased at a certain voltage (for example, a high voltage or a low voltage), so that the threshold voltage of the transistor is shifted, thereby affecting the display quality. The shift of the threshold voltage of the transistor may cause the current supplied to the light-emitting element (such as an OLED) in the pixel to change, thereby causing the brightness of the OLED to change. In addition, the difference in the degree of shift of the threshold voltage of each transistor may also result in uneven brightness of the display panel, resulting in a decrease in the brightness uniformity of the display panel, and even generating regional spots or patterns. Moreover, factors such as the IR drop of the voltage source and the aging of the OLED may also affect the brightness uniformity of the display. Therefore, compensation technology is needed to enable the brightness of the pixel to reach the ideal value.

In the usual compensation technology, transistors and/or capacitors need to be added in the pixel circuit. However, as the number of transistors and the number of capacitors increase, the power consumption of the pixel circuit also increases, and the complexity of the pixel circuit also increases accordingly, so that the production cost is increased and the reliability of the product is reduced. How to reduce the complexity of the pixel circuit and reduce the power consumption while implementing the threshold voltage compensation has become an urgent problem to be solved.

At least one embodiment of the present disclosure provides a display driving circuit, a method of driving a display driving circuit, a display panel, and a display device. The display driving circuit can reduce the complexity of the pixel circuit, and can also compensate for the shift of the threshold voltage of the transistor and reduce the power consumption, thereby reducing or avoiding the influence of the shift of the threshold voltage of the transistor on the current flowing through the light-emitting element, improving the display quality, and having the ability to quickly read and write data.

Hereinafter, some embodiments of the present disclosure are described in detail with reference to the accompany drawings. It should be noted that the same reference numerals in different drawings are used to refer to the same described elements.

At least one embodiment of the present disclosure provides a display driving circuit, and the display driving circuit includes a compensation circuit and at least one pixel circuit electrically connected to the compensation circuit. The pixel circuit is configured to receive a data compensation signal and control a current magnitude of a driving current flowing through a light-emitting element according to the data compensation signal, so as to apply an operating voltage to a first terminal of the light-emitting element. The compensation circuit is configured to receive the operating voltage and a data voltage, and adjust the data compensation signal according to a difference between the operating voltage and the data voltage, for example, to reduce the difference between the operating voltage and the data voltage until the operating voltage is equal to or substantially equal to the data voltage.

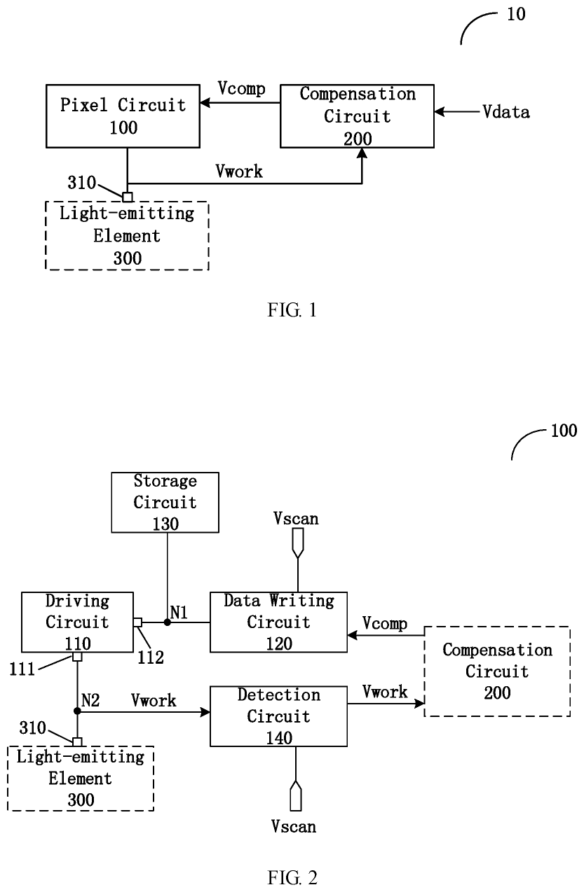

FIG. 1 is a schematic block diagram of a display driving circuit provided by some embodiments of the present disclosure. As illustrated in FIG. 1, a display driving circuit 10 includes a compensation circuit 200 and at least one pixel circuit 100 electrically connected to each other. For example, the display driving circuit 10 is used to drive a sub-pixel of an OLED display device.

For example, the pixel circuit 100 is configured to receive a data compensation signal Vcomp and control a current magnitude of a driving current flowing through a light-emitting element 300 according to the data compensation signal Vcomp, so as to apply an operating voltage Vwork to a first terminal 310 of the light-emitting element 300. For example, the pixel circuit 100 is connected to the compensation circuit 200 and the first terminal 310 of the light-emitting element 300, respectively, so as to receive the data compensation signal Vcomp from the compensation circuit 200 and provide the driving current to the light-emitting element 300 to drive the light-emitting element 300 to emit light. For example, the data compensation signal Vcomp is a voltage signal, and the voltage signal determines the current magnitude of the driving current, so that the light-emitting element 300 may emit light according to the required “gray level”.

When the pixel circuit 100 provides the driving current to the light-emitting element 300, the operating voltage Vwork is formed at the first terminal 310 of the light-emitting element 300, and the operating voltage Vwork is a voltage actually applied to the light-emitting element 300 so as to enable the light-emitting element 300 to operate. Because there may be a threshold voltage shift in the driving transistor of the pixel circuit 100, the brightness of the light-emitting element 300 may be different from the ideal value (that is, the brightness corresponding to the data voltage Vdata described below), and therefore, there is a difference between the operating voltage Vwork and the data voltage Vdata. For example, the light-emitting element 300 may be an OLED, and two terminals of the OLED are electrically connected to the pixel circuit 100 and an additionally provided low-voltage terminal (e.g., ground), respectively. The embodiments of the present disclosure include but are not limited to this case.

For example, the compensation circuit 200 is configured to receive the operating voltage Vwork and the data voltage Vdata, and adjust the data compensation signal Vcomp according to the difference between the operating voltage Vwork and the data voltage Vdata, so that the difference between the operating voltage Vwork and the data voltage Vdata is reduced, resulting in negative feedback effect. For example, in the data writing phase of the display period, the aforementioned difference may be reduced until the operating voltage Vwork is equal to or substantially equal to the data voltage Vdata. Here, “the operating voltage Vwork is equal to or substantially equal to the data voltage Vdata” refers to a state in which the compensation circuit 200 no longer changes the value of the data compensation signal Vcomp based on these two voltages (i.e., the operating voltage Vwork and the data voltage Vdata).

For example, the compensation circuit 200 is connected to the pixel circuit 100, the first terminal 310 of the light-emitting element 300, and an additionally provided data line, respectively, so as to receive the operating voltage Vwork from the first terminal 310 of the light-emitting element 300 and the data voltage Vdata provided by the data line and transmit the data compensation signal Vcomp to the pixel circuit 100.

For example, the data voltage Vdata corresponds to the light-emitting brightness (i.e., “gray level”) of the light-emitting element 300, that is, the data voltage Vdata may enable the pixel circuit 100 to drive the light-emitting element 300 to emit light according to the required “gray level” in the case where there is no shift of the threshold voltage of the driving transistor. In this case, the operating voltage Vwork of the light-emitting element 300 is equal to the data voltage Vdata. In the case where the threshold voltage of the driving transistor in the pixel circuit 100 shifts, the operating voltage Vwork is not equal to the data voltage Vdata, the compensation circuit 200 adjusts the magnitude of the data compensation signal Vcomp according to the difference between the operating voltage Vwork and the data voltage Vdata and provides the data compensation signal Vcomp to the pixel circuit 100, and the pixel circuit 100 generates the driving current according to the adjusted data compensation signal Vcomp. As the magnitude of the data compensation signal Vcomp changes, the current magnitude of the driving current also changes, so that the operating voltage Vwork of the light-emitting element 300 changes, and thus the light-emitting brightness of the light-emitting element 300 changes.

Through adjustment, where the operating voltage Vwork is equal to or substantially equal to the data voltage Vdata, the compensation circuit 200 keeps the data compensation signal Vcomp from changing so as to remain stable, so that the operating voltage Vwork of the light-emitting element 300 also remains stable and equal to or substantially equal to the data voltage Vdata under the action of the compensation circuit 200. In this case, the operating voltage Vwork of the light-emitting element 300 is equal to or substantially equal to the data voltage Vdata, so the light-emitting element 300 may emit light according to the required “gray level”, thereby compensating for the shift of the threshold voltage of the driving transistor in the pixel circuit 100, reducing or avoiding the influence of the shift of the threshold voltage of the driving transistor on the current flowing through the light-emitting element 300, and improving the display quality.

For example, the pixel circuit 100 is provided in each sub-pixel of a plurality of sub-pixels arranged in an array. In some embodiments, when the plurality of sub-pixels are scanned progressively, during the scanning time of each row of sub-pixels, the compensation circuit 200 adjusts the data compensation signal Vcomp according to the difference between the operating voltage Vwork and the data voltage Vdata, so that the difference between the operating voltage Vwork and the data voltage Vdata is reduced, for example, until the operating voltage Vwork is equal to or substantially equal to the data voltage Vdata. Therefore, at the end of the scanning of each row of sub-pixels, the operating voltage Vwork of the light-emitting element 300 in the sub-pixel reaches or substantially reaches the ideal value (i.e., the data voltage Vdata), and the light-emitting element 300 emits light according to the required “gray level” until the scanning of the next frame.

It should be noted that, in some embodiments of the present disclosure, the number of pixel circuits 100 in the display driving circuit 10 is not limited, and may be one or more. FIG. 1 illustrates only one pixel circuit 100, but this does not constitute a limitation to the embodiments of the present disclosure. For example, in some examples, there is one pixel circuit 100, and therefore, each sub-pixel of the display device corresponds to one display driving circuit 10, which is used to drive the corresponding sub-pixel to emit light. For example, in some other examples, there are a plurality of pixel circuits 100, that is, the plurality of pixel circuits 100 are all connected to the same one compensation circuit 200. Therefore, each column of sub-pixels of the display device corresponds to, for example, one display driving circuit 10, and the plurality of pixel circuits 100 are provided in each sub-pixel in the column of sub-pixels, respectively, and are connected to the same one compensation circuit 200. Because the sub-pixels are scanned progressively, the display driving circuit 10 may drive the corresponding column of sub-pixels to emit light.

For example, the pixel circuit 100 may be provided in the sub-pixel, and the compensation circuit 200 may be provided outside the sub-pixel, such as integrated in a data driving circuit, so as to reduce the complexity of the pixel circuit 100, thereby reducing power consumption and improving product reliability. Due to the voltage driving method, the display driving circuit 10 may also have the ability to quickly read and write data.

FIG. 2 is a schematic block diagram of a pixel circuit of a display driving circuit provided by some embodiments of the present disclosure. As illustrated in FIG. 2, the pixel circuit 100 includes a driving circuit 110, a data writing circuit 120, a storage circuit 130, and a detection circuit 140.

For example, the driving circuit 110 includes a first terminal 111 and a control terminal 112, and is configured to control the current magnitude of the driving current according to the data compensation signal Vcomp. The control terminal 112 of the driving circuit 110 is configured to be connected to a first node N1, and the first terminal 111 of the driving circuit 110 is configured to be connected to the first terminal 310 (a second node N2) of the light-emitting element 300. For example, the driving circuit 110 is also connected to an additionally provided high voltage terminal (not illustrated in the figure) so as to generate the driving current based on the data compensation signal Vcomp and the high voltage signal provided by the high voltage terminal, thereby driving the light-emitting element 300 to emit light.

For example, the data writing circuit 120 is connected to the control terminal 112 (the first node N1) of the driving circuit 110, and is configured to write the data compensation signal Vcomp into the control terminal 112 of the driving circuit 110 in response to a scanning signal Vscan. The data writing circuit 120 is connected to the compensation circuit 200, the first node N1, and the scanning line, respectively, so as to receive the data compensation signal Vcomp from the compensation circuit 200 and the scanning signal Vscan from the scanning line. For example, the scanning signal Vscan is applied to the data writing circuit 120 to control whether the data writing circuit 120 is turned on. Therefore, in the case where the data writing circuit 120 is turned on in response to the scanning signal Vscan, the data compensation signal Vcomp from the compensation circuit 200 can be written into the control terminal 112 (the first node N1) of the driving circuit 110, then the data compensation signal Vcomp can be stored in the storage circuit 130, and the stored data compensation signal Vcomp can be used to generate the driving current for driving the light-emitting element 300 to emit light.

For example, the storage circuit 130 is connected to the control terminal 112 (the first node N1) of the driving circuit 110, and is configured to store the data compensation signal Vcomp written by the data writing circuit 120. For example, the storage circuit 130 is also connected to an additionally provided high voltage terminal so as to realize the storage function. The storage circuit 130 may store the data compensation signal Vcomp and allow the stored data compensation signal Vcomp to control the driving circuit 110.

For example, the detection circuit 140 is connected to the first terminal 310 (the second node N2) of the light-emitting element 300 and is configured to transmit the operating voltage Vwork to the compensation circuit 200 in response to the scanning signal Vscan. The detection circuit 140 is connected to the second node N2, the compensation circuit 200, and the scanning line, respectively, so as to receive the scanning signal Vscan from the scanning line, and to be turned on under control of the scanning signal Vscan, thereby transmitting the voltage of the second node N2 (i.e., the operating voltage Vwork) to the compensation circuit 200.

For example, the first terminal 310 of the light-emitting element 300 is connected to the first terminal 111 (the second node N2) of the driving circuit 110 to receive the driving current, the second terminal of the light-emitting element 300 is connected to an additionally provided low voltage terminal (for example, grounded), and the light-emitting element 300 is configured to emit light according to the driving current from the driving circuit 110.

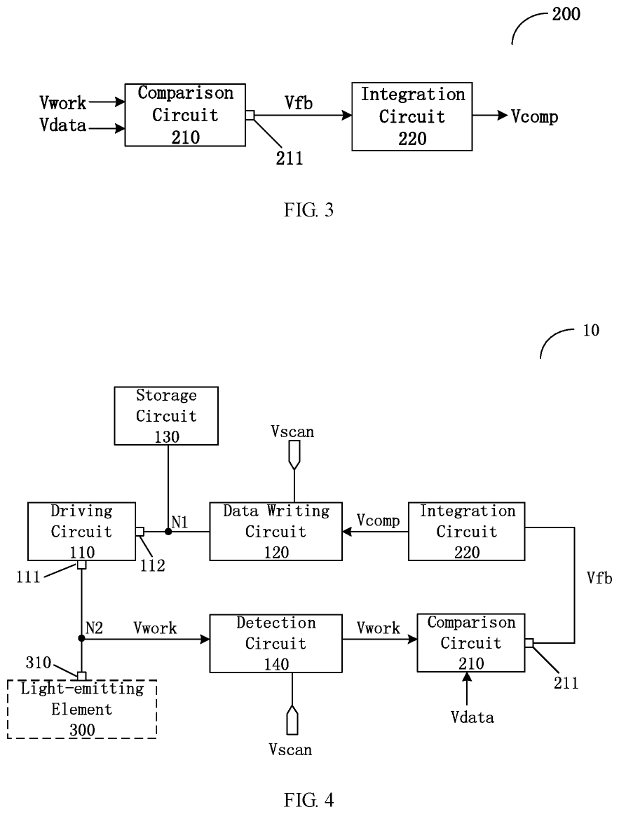

FIG. 3 is a schematic block diagram of a compensation circuit of a display driving circuit provided by some embodiments of the present disclosure. As illustrated in FIG. 3, the compensation circuit 200 includes a comparison circuit 210 and an integration circuit 220.

For example, the comparison circuit 210 includes an output terminal 211 and is configured to generate a feedback signal Vfb according to the difference between the operating voltage Vwork and the data voltage Vdata. For example, the comparison circuit 210 receives the operating voltage Vwork from the detection circuit 140 illustrated in FIG. 2 and is connected to the data line to receive the data voltage Vdata. The feedback signal Vfb has a corresponding relationship (e.g., positive correlation, proportional, or other correspondence) with the difference between the operating voltage Vwork and the data voltage Vdata, that is, the feedback signal Vfb reflects the difference between the operating voltage Vwork and the data voltage Vdata. For example, in some examples, the feedback signal Vfb is proportional to the difference between the operating voltage Vwork and the data voltage Vdata, that is, proportional to Vwork-Vdata.

For example, the integration circuit 220 is connected to the output terminal 211 of the comparison circuit 210 and is configured to perform an integration calculation on the feedback signal Vfb and generate the data compensation signal Vcomp. For example, in the case where the feedback signal Vfb is proportional to Vwork-Vdata, where the feedback signal Vfb is positive, the integration circuit 220 allows the data compensation signal Vcomp to be reduced; where the feedback signal Vfb is negative, the integration circuit 220 allows the data compensation signal Vcomp to be increased; where the feedback signal Vfb is zero, the integration circuit 220 keeps the data compensation signal Vcomp unchanged. The operating voltage Vwork is generated by the data compensation signal Vcomp, and therefore, the negative feedback effect is generated. For example, after the integration circuit 220 generates the data compensation signal Vcomp, the data compensation signal Vcomp is transmitted to the data writing circuit 120 illustrated in FIG. 2 and is written into the control terminal 112 (the first node N1) of the driving circuit 110 through the data writing circuit 120. For example, the integration circuit 220 adjusts the magnitude of the data compensation signal Vcomp according to the feedback signal Vfb, and accordingly, through the function of the pixel circuit 100, the magnitude of the operating voltage Vwork is also adjusted. Where the operating voltage Vwork is equal to the data voltage Vdata, the difference between the operating voltage Vwork and the data voltage Vdata is 0, and the feedback signal Vfb is also 0, so that the data compensation signal Vcomp generated by the integration circuit 220 remains unchanged, and the operating voltage Vwork also remains unchanged and is always equal to the data voltage Vdata. In this case, the light-emitting element 300 emits light according to the required “gray level”, and the shift of the threshold voltage of the driving transistor in the pixel circuit 100 is compensated.

FIG. 4 is a schematic block diagram of another display driving circuit provided by some embodiments of the present disclosure. As illustrated in FIG. 4, the pixel circuit 100 of the display driving circuit 10 is basically the same as the pixel circuit 100 illustrated in FIG. 2, and the compensation circuit 200 of the display driving circuit 10 is basically the same as the compensation circuit 200 illustrated in FIG. 3. The specific connection relationship and related description of the display driving circuit 10 may be with reference to the foregoing content, and details are not described herein again. It should be noted that the display driving circuit 10 provided by the embodiments of the present disclosure may also include other circuit structures, which is not limited in the embodiments of the present disclosure.

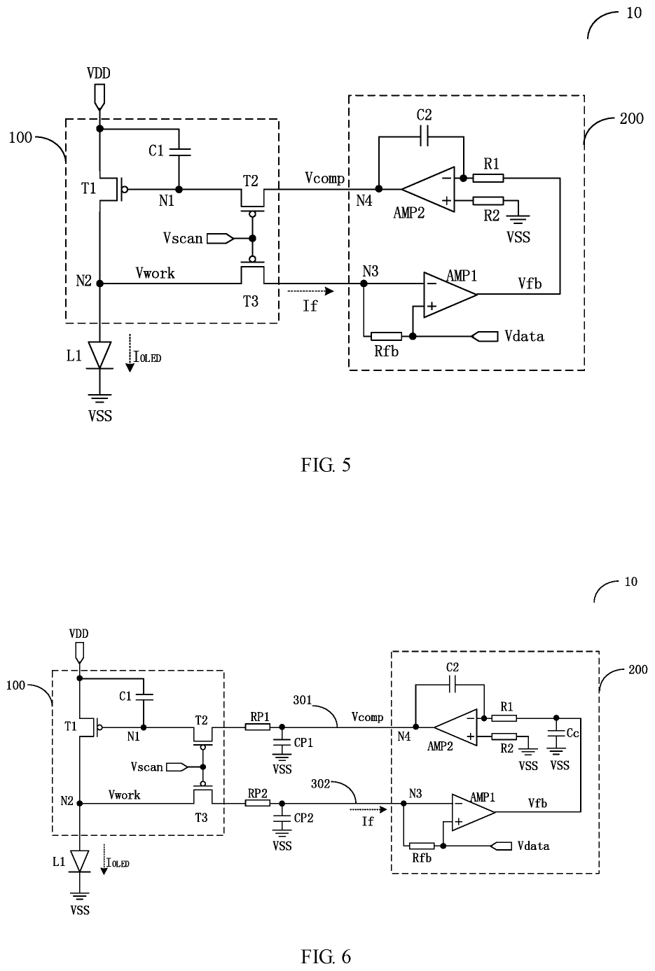

FIG. 5 is a circuit diagram (an equivalent circuit diagram) of a specific implementation example of the display driving circuit illustrated in FIG. 4. As illustrated in FIG. 5, the display driving circuit 10 includes first to third transistors T1 to T3, a first capacitor C1, a second capacitor C2, a first operational amplifier AMP1, a second operational amplifier AMP2, a feedback resistor Rfb, a first resistor R1, and a second resistor R2. For example, the first transistor T1 is used as a driving transistor, and the other transistors are used as switching transistors. For example, the light-emitting element L1 may be an OLED of various types, such as top-emission, bottom-emission, double-side emission, etc. The light-emitting element L1 may emit red light, green light, blue light, white light, or the like, and the embodiments of the present disclosure are not limited in this aspect.

For example, the driving circuit 110 may be implemented as the first transistor T1. A gate electrode of the first transistor T1 serves as the control terminal 112 of the driving circuit 110, a first electrode of the first transistor T1 is configured to be connected to a first voltage terminal VDD, and a second electrode of the first transistor T1 serves as the first terminal 111 of the driving circuit 110. For example, the first voltage terminal VDD is configured to keep providing a DC high-level signal, and the DC high-level signal is referred to as the first voltage. The following embodiments are the same as that, and details are not described again. It should be noted that the embodiments of the present disclosure are not limited to this case, and the driving circuit 110 may also be a circuit composed of other components. For example, the driving circuit 110 may have two groups of driving transistors, and for example, the two groups of driving transistors may be switched according to specific conditions.

For example, the data writing circuit 120 may be implemented as the second transistor T2. A gate electrode of the second transistor T2 is configured to be connected to the scanning line to receive the scanning signal Vscan, a first electrode of the second transistor T2 is configured to be connected to the compensation circuit 200 to receive the data compensation signal Vcomp, and a second electrode of the second transistor T2 is configured to be connected to the control terminal 112 (the first node N1) of the driving circuit 110. It should be noted that the embodiments of the present disclosure are not limited to this case, and the data writing circuit 120 may also be a circuit composed of other components.

For example, the storage circuit 130 may be implemented as the first capacitor C1. A first electrode of the first capacitor C1 is configured to be connected to the first voltage terminal VDD, and a second electrode of the first capacitor C1 is configured to be connected to the control terminal 112 (the first node N1) of the driving circuit 110. It should be noted that the embodiments of the present disclosure are not limited thereto, and the storage circuit 130 may also be a circuit composed of other components. For example, the storage circuit 130 may include two capacitors connected in parallel/series with each other.

For example, the detection circuit 140 may be implemented as the third transistor T3. A gate electrode of the third transistor T3 is configured to be connected to the scanning line to receive the scanning signal Vscan, a first electrode of the third transistor T3 is configured to be connected to the first terminal (the second node N2) of the light-emitting element L1, and a second electrode of the third transistor T3 is configured to be connected to the compensation circuit 200 to transmit the operating voltage Vwork. It should be noted that the embodiments of the present disclosure are not limited to this case, and the detection circuit 140 may also be a circuit composed of other components.

For example, the comparison circuit 210 may be implemented to include the first operational amplifier AMP1 and the feedback resistor Rfb. The first operational amplifier AMP1 includes a first input terminal (a non-inverting input terminal+), a second input terminal (an inverting input terminal −), and an output terminal. The first input terminal of the first operational amplifier AMP1 is configured to be connected to the data line to receive the data voltage Vdata, the second input terminal of the first operational amplifier AMP1 is configured to be connected to the pixel circuit 100 (for example, connected to the second electrode of the third transistor T3, that is, connected to the third node N3) to receive the operating voltage Vwork, and the output terminal of the first operational amplifier AMP1 serves as the output terminal 211 of the comparison circuit 210 and is connected to the integration circuit 220. A first terminal of the feedback resistor Rfb is configured to be connected to the second input terminal of the first operational amplifier AMP1, and a second terminal of the feedback resistor Rfb is configured to be connected to the first input terminal of the first operational amplifier AMP1. It should be noted that the embodiments of the present disclosure are not limited to this case, and the comparison circuit 210 may also be a circuit composed of other components.

For example, the integration circuit 220 may be implemented as the second operational amplifier AMP2, the first resistor R1, the second resistor R2, and the second capacitor C2. The second operational amplifier AMP2 includes a first input terminal (a non-inverting input terminal+), a second input terminal (an inverting input terminal −), and an output terminal. The first input terminal of the second operational amplifier AMP2 is configured to be connected to a first terminal of the second resistor R2, the second input terminal of the second operational amplifier AMP2 is configured to be connected to a first terminal of the first resistor R1, and the output terminal of the second operational amplifier AMP2 is connected to the pixel circuit 100 (for example, connected to the first electrode of the second transistor T2, that is, connected to the fourth node N4) so as to output the data compensation signal Vcomp. A second terminal of the first resistor R1 is configured to be connected to the output terminal 211 of the comparison circuit 210 (for example, connected to the output terminal of the first operational amplifier AMP1). A second terminal of the second resistor R2 is configured to be connected to a second voltage terminal VSS. A first electrode of the second capacitor C2 is configured to be connected to the output terminal of the second operational amplifier AMP2, and a second electrode of the second capacitor C2 is configured to be connected to the second input terminal of the second operational amplifier AMP2. For example, the second voltage terminal VSS is configured to keep providing a DC low-level signal (for example, a grounded signal), and the DC low-level signal is referred to as a second voltage. The following embodiments are the same as this, and details are not described again. It should be noted that the embodiments of the present disclosure are not limited to this case, and the integration circuit 220 may also be a circuit composed of other components.

The light-emitting element 300 may be implemented as the light-emitting element L1 (for example, an organic light-emitting diode (OLED), a quantum dot light-emitting diode (QLED), an inorganic LED (for example, a micro LED), etc.). A first terminal (here, the anode) of the light-emitting element L1 serves as the first terminal 310 of the light-emitting element 300 and is configured to be connected to the second node N2, and is also configured to receive the driving current from the first terminal 111 of the driving circuit 110. A second terminal (here, the cathode) of the light-emitting element L1 is connected to the second voltage terminal VSS. For example, in a display panel, when pixel circuits 100 in a plurality of sub-pixels are arranged in an array, the cathode of the light-emitting element L1 in the pixel circuit 100 in each sub-pixel may be electrically connected to the same voltage terminal, that is, the display panel adopts the cathode sharing connection.

FIG. 6 is a circuit diagram (an equivalent circuit diagram) of another specific implementation example of the display driving circuit illustrated in FIG. 4. As illustrated in FIG. 6, in addition to further including a first line resistor RP1, a second line resistor RP2, a first coupling capacitor CP1, a second coupling capacitor CP2, and a third coupling capacitor Cc, the display driving circuit 10 of this embodiment is substantially the same as the display driving circuit 10 illustrated in FIG. 5.

In this embodiment, the pixel circuit 100 and the compensation circuit 200 are connected through a first transmitting line 301 and a second transmitting line 302. The first transmitting line 301 is used to transmit the data compensation signal Vcomp, and the second transmitting line 302 is used to transmit the operating voltage Vwork. In the case where the pixel circuit 100 is provided in the sub-pixel and the compensation circuit 200 is provided outside the sub-pixel, the length of the first transmitting line 301 and the length of the second transmitting line 302 are relatively long, and therefore, there is corresponding line resistance. The first line resistor RP1 represents the line resistance of the first transmitting line 301, and the second line resistor RP2 represents the line resistance of the second transmitting line 302. In addition, the first transmitting line 301 has a first coupling capacitor CP1 to the ground, and the second transmitting line 302 has a second coupling capacitor CP2 to the ground. For example, the signal line used for connecting the output terminal of the first operational amplifier AMP1 and the first resistor R1 also has a third coupling capacitor Cc to the ground. It should be noted that the first coupling capacitor CP1, the second coupling capacitor CP2, and the third coupling capacitor Cc are not specifically manufactured capacitive components, but are generated by the coupling of the corresponding cable and the grounded terminal. The first line resistor RP1 and the second line resistor RP2 are not specifically manufactured resistance components, but are the line resistance of the first transmitting line 301 and the line resistance of the second transmitting line 302.

It should be noted that in the descriptions of the various embodiments of the present disclosure, the first node N1, the second node N2, the third node N3, and the fourth node N4 do not represent actual components, but represent intersection points of related electrical connections in the circuit diagrams.

It should be noted that the transistors used in the embodiments of the present disclosure may be thin film transistors, field effect transistors, or other switching components with the same characteristics. In the embodiments of the present disclosure, thin film transistors are used as examples for description. The source electrode and drain electrode of the transistor used here may be symmetrical in structure, so that the source electrode and drain electrode may be structurally indistinguishable. In the embodiments of the present disclosure, in order to distinguish the two electrodes of the transistor other than the gate electrode, one electrode is directly described as the first electrode and the other electrode is directly described as the second electrode.

In addition, the transistors in the embodiments of the present disclosure are described by taking P-type transistors as examples. In this case, the first electrode of the transistor is the source electrode, and the second electrode of the transistor is the drain electrode. It should be noted that the present disclosure includes but is not limited to this case. For example, one or more transistors in the display driving circuit 10 provided by the embodiments of the present disclosure may also be N-type transistors. In this case, the first electrode of the transistor is the drain electrode and the second electrode of the transistor is the source electrode. The electrodes of the selected type of transistors are connected correspondingly with reference to the electrodes of the corresponding transistors in the embodiments of the present disclosure, and the corresponding voltage terminals and signal terminals provide corresponding high-level signals or low-level signals. In the case where N-type transistors are used, indium gallium zinc oxide (IGZO) may be used as the active layer of the thin film transistor. Compared with low temperature poly-silicon (LTPS) or amorphous silicon (such as hydrogenated amorphous silicon) used as the active layer of the thin film transistor, using IGZO as the active layer of the thin film transistor may effectively reduce the size of the transistor and prevent leakage current. In the case where P-type transistors are used, low temperature poly-silicon (LTPS) or amorphous silicon (for example, hydrogenated amorphous silicon) may be used as the active layer of the thin film transistor.

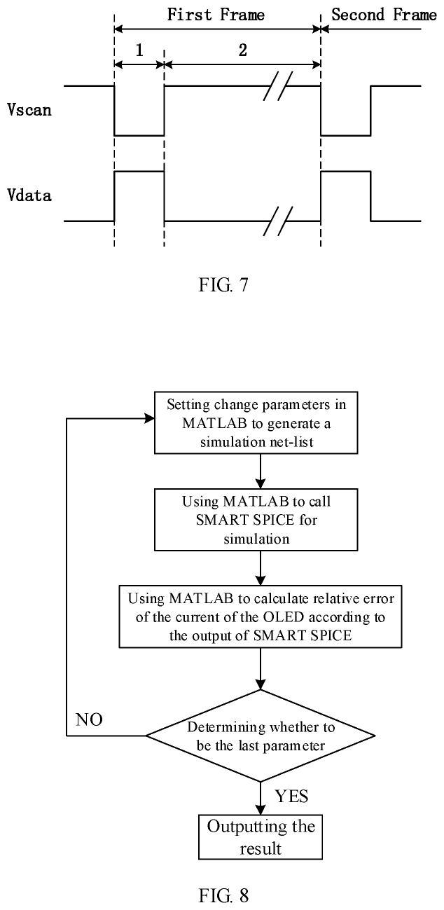

FIG. 7 is a signal timing diagram of a display driving circuit provided by some embodiments of the present disclosure. The working principle of the display driving circuit 10 illustrated in FIG. 5 is described below with reference to the signal timing diagram illustrated in FIG. 7. Here, the description is provided by taking each transistor as a P-type transistor as an example, but the embodiments of the present disclosure are not limited to this case. One frame of operating time (a display period) of the display driving circuit 10 includes a data writing phase 1 and a data maintaining phase 2, which are specifically described as follows.

In the data writing phase 1, the scanning signal Vscan is at a low level, and the second transistor T2 and the third transistor T3 are turned on. In this case, the first transistor T1 is turned on under control of the voltage stored in the first capacitor C1 and provides a corresponding driving current to the light-emitting element L1. It should be noted that during the initial period of the data writing phase 1, the voltage stored in the first capacitor C1 may be a voltage written during the scanning of the previous frame, or may be a random voltage generated after the display panel is powered on, or may be a voltage written into the first capacitor C1 in other manners, which is not limited in the embodiments of the present disclosure. The driving current flows through the light-emitting element L1, and therefore, the operating voltage Vwork is generated at the first terminal (the second node N2) of the light-emitting element L1. In this case, the data line provides the data voltage Vdata, and the data line is, for example, electrically connected to an output terminal of an additionally provided data driving circuit so as to receive the data voltage Vdata from the data driving circuit. Because the light-emitting element L1 does not emit light according to the required brightness in this period, the operating voltage Vwork is not equal to the data voltage Vdata, and there is a certain difference between the operating voltage Vwork and the data voltage Vdata. Therefore, a feedback current If is generated between the second node N2 and the first input terminal of the first operational amplifier AMP1. The feedback current If reflects the difference between the operating voltage Vwork and the data voltage Vdata. The feedback resistor Rfb generates an error voltage under the action of the feedback current If, and the first operational amplifier AMP1 generates a feedback signal Vfb accordingly.

For example, the feedback signal Vfb is expressed as:

Vfb=If×Rfb×G1,

where If represents the current (that is, the feedback current described above) generated between the pixel circuit 100 and the compensation circuit 200 due to the difference between the operating voltage Vwork and the data voltage Vdata, Rfb represents the resistance value of the feedback resistor Rfb, and G1 represents the magnification of the first operational amplifier AMP1.

The feedback signal Vfb enters the second operational amplifier AMP2 through the first resistor R1, and the second operational amplifier AMP2 performs an integration calculation on the feedback signal Vfb and generates the data compensation signal Vcomp. For example, the data compensation signal Vcomp at time t1 is Vout(t1), the data compensation signal Vcomp at time t2 is Vout(t2), and Vout(t1) and Vout(t2) may be expressed as the following formula:

$$Vout ( t 2 ) = - \frac{1}{R 1 C} {\int }_{t 1}^{t 2} Vfb \times dt + Vout ( t 1 ) ,$$

where R1 represents the resistance value of the first resistor R1, C represents the capacitance value of the second capacitor C2, and Vfb represents the feedback signal. For example, the first transistor T1 works in a saturated state. The operating voltage Vwork at time t1 is Vwork(t1). At time t1, the voltage difference Vgs between the gate electrode and the second electrode of the first transistor T1 is equal to the threshold voltage Vth of the first transistor T1, that is, Vout(t1)−Vwork(t1)=Vgs=Vth.

The data compensation signal Vcomp is written into the first node N1 through the turned-on second transistor T2, and is stored by the first capacitor C1. The first transistor T1 is turned on in response to the data compensation signal Vcomp and provides the corresponding driving current to the light-emitting element L1. In this case, the operating voltage Vwork changes from the value in the initial period of the data writing phase 1.

In this case, if the operating voltage Vwork is equal to the data voltage Vdata, the difference between the operating voltage Vwork and the data voltage Vdata is 0, the feedback current If is 0, and accordingly, the feedback signal Vfb is also 0. The data compensation signal Vcomp generated by the second operational amplifier AMP2 remains unchanged, so that the potential of the first node N1 remains unchanged, and the driving current provided by the first transistor T1 to the light-emitting element L1 remains unchanged, so as to allow the operating voltage Vwork to remain unchanged and equal to the data voltage Vdata. Therefore, the operating voltage Vwork actually applied to the light-emitting element L1 is equal to the data voltage Vdata, and the light-emitting element L1 emits light according to the required brightness, thereby compensating for the shift of the threshold voltage of the driving transistor (for example, the first transistor T1), improving the brightness uniformity of the display panel, and improving the display quality.

In this case, if the operating voltage Vwork is not equal to the data voltage Vdata, the first operational amplifier AMP1 continues to generate the feedback signal Vfb according to the difference between the operating voltage Vwork and the data voltage Vdata. The second operational amplifier AMP2 performs integration on the feedback signal Vfb to adjust the magnitude of the data compensation signal Vcomp, thereby adjusting the potential of the first node N1 to adjust the turn-on degree of the first transistor T1, and further adjusting the magnitude of the driving current and the magnitude of the operating voltage Vwork so as to reduce the difference between the operating voltage Vwork and the data voltage Vdata, for example, until the operating voltage Vwork is equal to or substantially equal to the data voltage Vdata. It should be noted that the second operational amplifier AMP2 performs an integration calculation on the feedback signal Vfb, so that the data compensation signal Vcomp continuously changes, thereby allowing the potential of the first node N1 (that is, the control voltage of the first transistor T1) to continuously change. Therefore, the driving current of the first transistor T1 may not change suddenly, and the light-emitting element L1 may not have problems such as flicker.

In the data maintaining phase 2, the scanning signal Vscan is at a high level, the second transistor T2 and the third transistor T3 are turned off, and the pixel circuit 100 is disconnected from the compensation circuit 200. The voltage stored in the first capacitor C1 keeps the first transistor T1 turned on and the turn-on degree remains unchanged, so that the driving current and the operating voltage Vwork remain unchanged. In the data writing phase 1, the operating voltage Vwork is adjusted to be equal to or substantially equal to the data voltage Vdata, and therefore, in the data maintaining phase 2, the operating voltage Vwork remains equal to or substantially equal to the data voltage Vdata, and the light-emitting element L1 continues to emit light according to the required brightness until the scanning of the next frame.

For example, the first operational amplifier AMP1 and the feedback resistor Rfb are connected to form a voltage feedback circuit, and the second operational amplifier AMP2 is connected to the first resistor R1, the second resistor R2, and the second capacitor C2 to form an integration circuit. In the case where the operating voltage Vwork is greater than the data voltage Vdata, it means that the driving current is relatively large. Due to the effects of the first operational amplifier AMP1 and the second operational amplifier AMP2, the data compensation signal Vcomp may decrease, thereby allowing the driving current to be reduced. In the case where the operating voltage Vwork is less than the data voltage Vdata, it means that the driving current is relatively small. Due to the effects of the first operational amplifier AMP1 and the second operational amplifier AMP2, the data compensation signal Vcomp may increase, thereby allowing the driving current to be increased. When the stable state is reached, the operating voltage Vwork is equal to or substantially equal to the data voltage Vdata.

The display driving circuit 10 amplifies and feedbacks the feedback current If, and adjusts the data compensation signal Vcomp so as to adjust the control voltage of the first transistor T1 which influences the feedback current If, thereby implementing dynamic closed-loop adjustment. When the threshold voltage of the first transistor T1 shifts, the corresponding driving current may change, so that the operating voltage Vwork may change. The feedback signal Vfb can feedback the change of the operating voltage Vwork in time, and a suitable data compensation signal Vcomp after the compensation calculation is calculated by the second operational amplifier AMP2 and then is output. The data compensation signal Vcomp can ensure that the driving current of the first transistor T1 resumes to the desired value, so as to ensure that the brightness of the light-emitting element L1 is stable. Only in the case where the operating voltage Vwork is equal to the data voltage Vdata, the feedback current If is equal to 0. In this case, the current flowing through the light-emitting element L1 is equal to the current flowing through the first transistor T1.

Because the current flowing through the light-emitting element L1 is determined by the operating voltage Vwork and is not affected by the shift of the threshold voltage of the driving transistor (the first transistor T1), the shift of the threshold voltage of the driving transistor can be compensated, and the influence of the shift of the threshold voltage of the transistor on the current flowing through the light-emitting element L1 can be reduced or avoided, thereby improving the display uniformity and improving the display quality. The pixel circuit 100 in the display driving circuit 10 only needs to use three transistors (i.e., the first to third transistors T1 to T3) and one capacitor (i.e., the first capacitor C1), so that the complexity of the pixel circuit 100 may be reduced, the circuit structure may be simplified, the number of transistors may be reduced, and the power consumption may be effectively reduced. Because the data compensation signal Vcomp is a voltage signal, the circuit has the ability to quickly read and write data.

It should be noted that in the data writing phase 1, the operating voltage Vwork is adjusted to be equal to or substantially equal to the data voltage Vdata through a dynamic adjustment process. Although the brightness of the light-emitting element L1 may change accordingly during the adjustment process, the period is short, so that the display effect may not be affected.

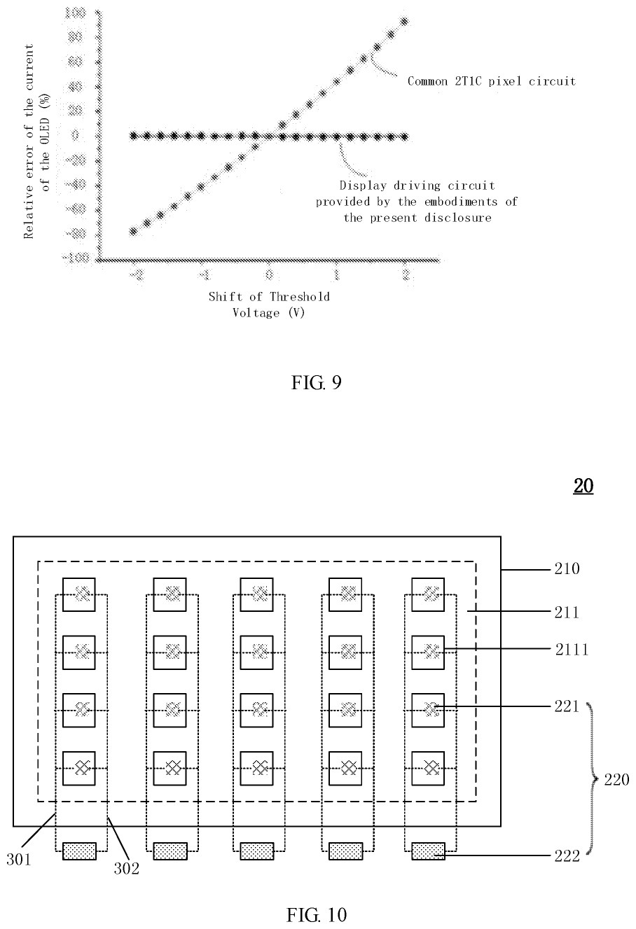

FIG. 8 is a simulation flowchart of a display driving circuit provided by some embodiments of the present disclosure. According to the flow, MATLAB and SMRT SPICE are used to simulate the display driving circuit 10. Firstly, the change parameters are set in MATLAB to generate a simulation net-list. For example, the change parameters correspond to the threshold voltage Vth of the first transistor T1. Secondly, MATLAB is used to call SMART SPICE for simulation. Then, MATLAB is used to calculate the relative error of the current of the OLED according to the output of SMART SPICE, until the calculation of the last parameter is completed and the result is output. In this simulation, the initial value of the threshold voltage Vth is 0V, the maximum shift is 2V, and the simulation result is illustrated in FIG. 9. It can be seen from FIG. 9 that when the threshold voltage Vth of the driving transistor in the usual 2T1C pixel circuit shifts by 1V, the relative current error exceeds 40%, and when the threshold voltage Vth shifts by 2V, the relative current error reaches 80%. The shift of the threshold voltage Vth may cause the current of the OLED to be too small, which may greatly reduce the display brightness. It can be seen from FIG. 9 that the display driving circuit 10 provided by the embodiments of the present disclosure has a relative current error within 1% after the threshold voltage Vth shifts beyond 2V. It can be seen that the display driving circuit 10 is not sensitive to the shift of the threshold voltage Vth, so that the threshold voltage Vth may be effectively compensated.

At least one embodiment of the present disclosure further provides a display panel. The display panel includes an array substrate and a plurality of display driving circuits according to any one of the embodiments of the present disclosure. The array substrate includes a pixel array region, and the pixel array region includes a plurality of sub-pixels arranged in an array. Pixel circuits of the plurality of display driving circuits are respectively provided in the plurality of sub-pixels in the pixel array region of the array substrate, and compensation circuits of the display driving circuits are provided outside the pixel array region. The display panel may reduce the complexity of the pixel circuit, and may not only compensate for the shift of the threshold voltage of the transistor but also reduce the power consumption, thereby reducing or avoiding the influence of the shift of the threshold voltage of the transistor on the current flowing through the light-emitting element, improving the display quality, and having the ability to read and write data quickly.

FIG. 10 is a schematic diagram of a display panel provided by some embodiments of the present disclosure. As illustrated in FIG. 10, a display panel 20 includes an array substrate 210 and a plurality of display driving circuits 220. The display driving circuit 220 may be the display driving circuit according to any one of the embodiments of the present disclosure, and for example, may be the display driving circuit 10 illustrated in FIG. 5 or FIG. 6. The array substrate 210 includes a pixel array region 211, and the pixel array region 211 includes a plurality of sub-pixels 2111 arranged in an array. The pixel circuits 221 of the display driving circuits 220 are respectively located in the plurality of sub-pixels 2111 in the pixel array region 211 of the array substrate 210, and the compensation circuits 222 of the display driving circuits 220 are located outside the pixel array region 211. For example, the compensation circuit 222 may be provided on the array substrate 210 or may be provided outside the array substrate 210. The pixel circuit 221 is provided in the sub-pixel 2111, and the compensation circuit 222 is not provided in the sub-pixel 2111, so that the circuit structure in the sub-pixel 2111 may be simplified and the power consumption may be reduced.

For example, the display panel 20 further includes a plurality of first transmitting lines 301 and a plurality of second transmitting lines 302. Each display driving circuit 220 corresponds to a first transmitting line 301 and a second transmitting line 302. The first transmitting line 301 is connected between the pixel circuit 221 and the compensation circuit 222 of the corresponding display driving circuit 220 so as to transmit the data compensation signal Vcomp, and the second transmitting line 302 is connected between the pixel circuit 221 and the compensation circuit 222 of the corresponding display driving circuit 220 so as to transmit the operating voltage Vwork.

For example, the pixel circuits 221 in each column of sub-pixels 2111 are connected to the same compensation circuit 222 through the same first transmitting line 301, and the pixel circuits 221 in each column of sub-pixels 2111 are connected to the same compensation circuit 222 through the same second transmitting line 302. In other words, the display driving circuit 220 includes a plurality of pixel circuits 221 and one compensation circuit 222, and each display driving circuit 220 corresponds to a column of sub-pixels 2111. In this way, the circuit structure can be simplified, resource utilization rate can be improved, and cost can be reduced. Because the sub-pixels 2111 are scanned progressively, the pixel circuits 221 in the sub-pixels 2111 in the same column are connected to the same first transmitting line 301 and the same second transmitting line 302 so as to achieve corresponding functions. It should be noted that in some other embodiments, the pixel circuit 221 and the compensation circuit 222 may also be arranged in one-to-one correspondence, that is, the display driving circuit 220 may include one pixel circuit 221 and one compensation circuit 222. The embodiments of the present disclosure are not limited in this aspect.

FIG. 11 is a schematic diagram of another display panel provided by some embodiments of the present disclosure. As illustrated in FIG. 11, except for further including a data driving circuit 230, the display panel 20 of this embodiment is basically the same as the display panel 20 illustrated in FIG. 10. In this embodiment, the compensation circuit 222 is provided in the data driving circuit 230. The data driving circuit 230 is, for example, a common data driver or a data driving integrated circuit (IC). The compensation circuit 222 may be provided in the data driving circuit 230 by adding chips or circuit structures, or by adopting other suitable methods. In this way, external resistors or additional manufacturing techniques or processes are not needed, which may facilitate manufacture. Further, this method can transfer the function of compensating for shift of the threshold voltage from the pixel circuit to the external driving circuit, so as to simplify the structure of the pixel circuit. For example, a plurality of compensation circuits 222 are integrated into one circuit, so that the circuit structure can be further simplified.

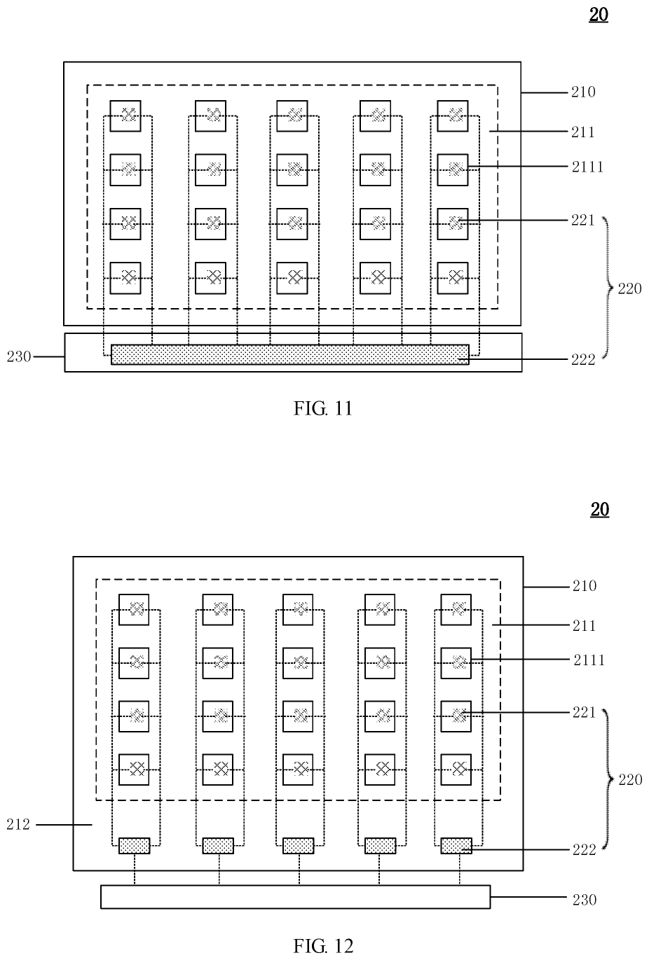

FIG. 12 is a schematic diagram of another display panel provided by some embodiments of the present disclosure. As illustrated in FIG. 12, except for the arrangement of the compensation circuit 222, the display panel 20 of this embodiment is basically the same as the display panel 20 illustrated in FIG. 11. In this embodiment, the array substrate 210 further includes a peripheral region 212 outside the pixel array region 211, and the compensation circuit 222 is located in the peripheral region 212 and is electrically connected to the data driving circuit 230. For example, the compensation circuit 222 may be fabricated on the array substrate 210 together with the pixel circuit 221 by using a semiconductor manufacturing process. In this manner, the structure and function of the data driving circuit 230 may not be changed, and the lead connection manner of the data driving circuit 230 and the array substrate 210 may not be changed.

At least one embodiment of the present disclosure further provides a display device which includes the display panel according to any one of the embodiments of the present disclosure. The display device may reduce the complexity of the pixel circuit, and may not only compensate for the shift of the threshold voltage of the transistor, but also reduce the power consumption, thereby reducing or avoiding the influence of the shift of the threshold voltage of the transistor on the current flowing through the light-emitting element, improving the display quality, and having the ability to read and write data quickly.

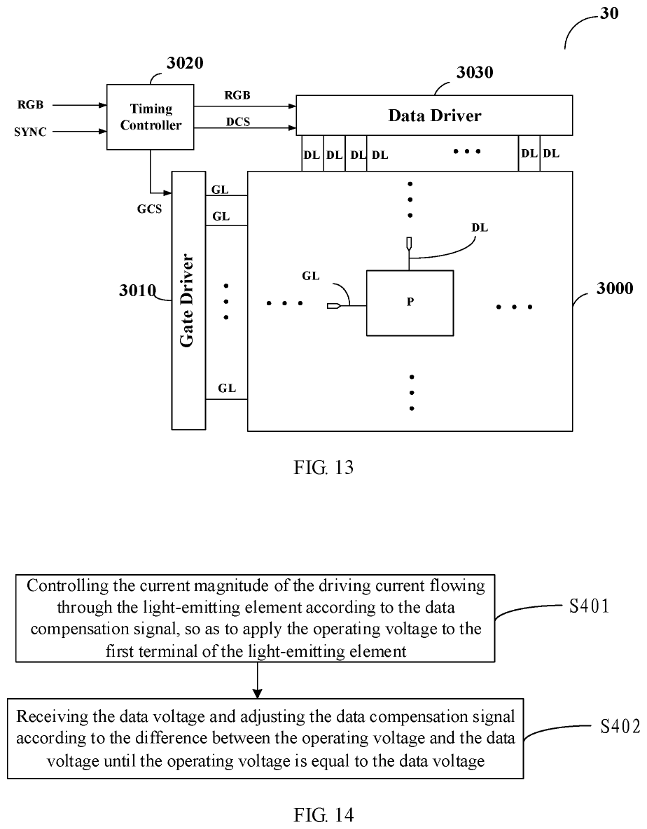

FIG. 13 is a schematic block diagram of a display device provided by some embodiments of the present disclosure. As illustrated in FIG. 13, a display device 30 includes a display panel 3000, and the display panel 3000 may be the display panel according to any one of the embodiments of the present disclosure. For example, the display device 30 may be any product or component with a display function, such as an OLED panel, an OLED TV, a display, a mobile phone, a tablet computer, a notebook computer, a digital photo frame, a navigator, or the like, which is not limited in the embodiments of the present disclosure. The technical effects of the display device 30 may be with reference to the above descriptions of the display driving circuit 10 and the display panel 20, and details are not described herein again.

For example, in an example, the display device 30 includes a display panel 3000, a gate driver 3010, a timing controller 3020, and a data driver 3030. The display panel 3000 includes a plurality of pixel units P defined according to intersections of a plurality of gate lines GL and a plurality of data lines DL. The gate driver 3010 is used to drive the plurality of gate lines GL. The data driver 3030 is used to drive the plurality of data lines DL. The timing controller 3020 is used to process the image data RGB input from the outside of the display device 30, provide the processed image data RGB to the data driver 3030, and output scanning control signals GCS and data control signals DCS to the gate driver 3010 and the data driver 3030, so as to control the gate driver 3010 and the data driver 3030.

For example, the display panel 3000 includes the display driving circuit 10 provided in any one of the above embodiments. For example, the pixel circuit 100 in the display driving circuit 10 is provided in the pixel unit P in the pixel array region of the array substrate of the display panel 3000, and the compensation circuit 200 in the display driving circuit 10 is provided outside the pixel array region. For example, the compensation circuit 200 may be disposed on the array substrate or integrated in the data driver 3030, which is not limited in the embodiments of the present disclosure.

For example, the plurality of gate lines GL are correspondingly connected to the pixel units P arranged in a plurality of rows. For example, the gate driver 3010 may be implemented as a semiconductor chip, or may be integrated in the display panel 3000 to form a GOA circuit.

For example, the data driver 3030 uses the reference gamma voltage to convert the digital image data RGB input from the timing controller 3020 into data signals according to the plurality of data control signals DCS from the timing controller 3020. The data driver 3030 provides the converted data signals to the plurality of data lines DL. For example, the data driver 3030 may be implemented as a semiconductor chip.

For example, the timing controller 3020 processes externally input image data RGB to match the size and resolution of the display panel 3000, and then provides the processed image data to the data driver 3030. The timing controller 3020 uses synchronization signals (such as a dot clock DCLK, a data enable signal DE, a horizontal synchronization signal Hsync, and a vertical synchronization signal Vsync) input from the outside of the display device 30 to generate the plurality of scanning control signals GCS and the plurality of data control signals DCS. The timing controller 3020 provides the generated scanning control signals GCS and data control signals DCS to the gate driver 3010 and the data driver 3030, respectively, for controlling the gate driver 3010 and the data driver 3030.

The display device 30 may also include other components, such as a signal decoding circuit, a voltage conversion circuit, etc. For example, these components may use existing conventional components, and details are not described herein again.

At least one embodiment of the present disclosure further provides a method of driving the display driving circuit according to any one of the embodiments of the present disclosure, and for example, the method may be used to drive the display driving circuit 10 according to any one of the embodiments of the present disclosure. By using this method, the complexity of the pixel circuit can be reduced, the shift of the threshold voltage of the transistor can be compensated, and the power consumption can be reduced, thereby reducing or avoiding the influence of the shift of the threshold voltage of the transistor on the current flowing through the light-emitting element, improving the display quality, and allowing the display driving circuit to have the ability to read and write data quickly.

FIG. 14 is a schematic flowchart of a method of driving a display driving circuit provided by some embodiments of the present disclosure. For example, in some examples, as illustrated in FIG. 14, the method of driving the display driving circuit includes the following operations.

Step S401: controlling the current magnitude of the driving current flowing through the light-emitting element 300 according to the data compensation signal Vcomp, so as to apply the operating voltage Vwork to the first terminal 310 of the light-emitting element 300.

Step S402: receiving the data voltage Vdata and adjusting the data compensation signal Vcomp according to the difference between the operating voltage Vwork and the data voltage Vdata, for example, to reduce the difference between the operating voltage Vwork and the data voltage Vdata until the operating voltage Vwork is equal to or substantially equal to the data voltage Vdata.

It should be noted that the method may further include more steps, and the sequence between the steps may be determined according to actual requirements, and is not limited to the sequence described above. The detailed descriptions and technical effects of the method may be with reference to the corresponding descriptions of the display driving circuit 10 in the embodiments of the present disclosure, and details are not described herein again.

The following statements need to be noted.

(1) The drawings of the embodiments of the present disclosure involve only the structures related to the embodiments of the present disclosure, and other structures may be referred to general design.

(2) In case of no conflict, the embodiments of the present disclosure and the features in the embodiments can be combined with each other to obtain new embodiments.

What have been described above merely are specific implementations of the present disclosure, but the protection scope of the present disclosure is not limited to this. The protection scope of the present disclosure is determined by the appended claims.

1. A display driving circuit, comprising a compensation circuit and at least one pixel circuit electrically connected to the compensation circuit,
wherein the pixel circuit is configured to receive a data compensation signal and control a current magnitude of a driving current flowing through a light-emitting element according to the data compensation signal, so as to apply an operating voltage to a first terminal of the light-emitting element; and
the compensation circuit is configured to receive the operating voltage and a data voltage, and adjust the data compensation signal according to a difference between the operating voltage and the data voltage.

2. The display driving circuit according to claim 1, wherein the pixel circuit comprises a driving circuit, a data writing circuit, a storage circuit, and a detection circuit;
the driving circuit comprises a control terminal and a first terminal, and is configured to control the current magnitude of the driving current according to the data compensation signal, and the first terminal of the driving circuit is connected to the first terminal of the light-emitting element;
the data writing circuit is connected to the control terminal of the driving circuit, and is configured to write the data compensation signal into the control terminal of the driving circuit in response to a scanning signal;
the storage circuit is connected to the control terminal of the driving circuit, and is configured to store the data compensation signal; and
the detection circuit is connected to the first terminal of the light-emitting element, and is configured to transmit the operating voltage to the compensation circuit in response to the scanning signal.

3. The display driving circuit according to claim 1, wherein the compensation circuit comprises a comparison circuit and an integration circuit;
the comparison circuit comprises an output terminal, and is configured to generate a feedback signal according to the difference between the operating voltage and the data voltage; and
the integration circuit is connected to the output terminal of the comparison circuit, and is configured to perform an integration calculation on the feedback signal and generate the data compensation signal.

4. The display driving circuit according to claim 2, wherein the driving circuit comprises a first transistor,
a gate electrode of the first transistor serves as the control terminal of the driving circuit, a first electrode of the first transistor is connected to a first voltage terminal, and a second electrode of the first transistor serves as the first terminal of the driving circuit.

5. The display driving circuit according to claim 2, wherein the data writing circuit comprises a second transistor,
a gate electrode of the second transistor is connected to a scanning line to receive the scanning signal, a first electrode of the second transistor is connected to the compensation circuit to receive the data compensation signal, and a second electrode of the second transistor is connected to the control terminal of the driving circuit.

6. The display driving circuit according to claim 2, wherein the storage circuit comprises a first capacitor,
a first electrode of the first capacitor is connected to a first voltage terminal, and a second electrode of the first capacitor is connected to the control terminal of the driving circuit.

7. The display driving circuit according to claim 2, wherein the detection circuit comprises a third transistor,
a gate electrode of the third transistor is connected to a scanning line to receive the scanning signal, a first electrode of the third transistor is connected to the first terminal of the light-emitting element, and a second electrode of the third transistor is connected to the compensation circuit to transmit the operating voltage.

8. The display driving circuit according to claim 3, wherein the comparison circuit comprises a first operational amplifier and a feedback resistor;
the first operational amplifier comprises a first input terminal, a second input terminal, and an output terminal, the first input terminal of the first operational amplifier is connected to a data line to receive the data voltage, the second input terminal of the first operational amplifier is connected to the pixel circuit to receive the operating voltage, and the output terminal of the first operational amplifier serves as the output terminal of the comparison circuit and is connected to the integration circuit; and
a first terminal of the feedback resistor is connected to the second input terminal of the first operational amplifier, and a second terminal of the feedback resistor is connected to the first input terminal of the first operational amplifier.

9. The display driving circuit according to claim 8, wherein the feedback signal is expressed as:
Vfb=If×Rfb×G1,
wherein Vfb represents the feedback signal, If represents a current generated between the pixel circuit and the comparison circuit due to the difference between the operating voltage and the data voltage, Rfb represents a resistance value of the feedback resistor, and G1 represents a magnification of the first operational amplifier.

10. The display driving circuit according to claim 3, wherein the integration circuit comprises a second operational amplifier, a first resistor, a second resistor, and a second capacitor;
the second operational amplifier comprises a first input terminal, a second input terminal, and an output terminal, the first input terminal of the second operational amplifier is connected to a first terminal of the second resistor, the second input terminal of the second operational amplifier is connected to a first terminal of the first resistor, and the output terminal of the second operational amplifier is connected to the pixel circuit to output the data compensation signal;
a second terminal of the first resistor is connected to the output terminal of the comparison circuit;
a second terminal of the second resistor is connected to a second voltage terminal; and
a first electrode of the second capacitor is connected to the output terminal of the second operational amplifier, and a second electrode of the second capacitor is connected to the second input terminal of the second operational amplifier.

11. The display driving circuit according to claim 10, wherein the data compensation signal is expressed as:
$$Vout ( t 2 ) = - \frac{1}{R 1 C} {\int }_{t 1}^{t 2} Vfb \times dt + Vout ( t 1 ) ,$$
wherein Vout(t2) represents a data compensation signal at time t2, Vout(t1) represents a data compensation signal at time t1, R1 represents a resistance value of the first resistor, C represents a capacitance value of the second capacitor, and Vfb represents the feedback signal.

12. The display driving circuit according to claim 1, wherein the compensation circuit is further configured to receive the operating voltage and the data voltage and adjust the data compensation signal according to the difference between the operating voltage and the data voltage, so as to allow the operating voltage to be equal to the data voltage.

13. A display panel, comprising a plurality of display driving circuits and an array substrate,
wherein the display driving circuit comprises a compensation circuit and at least one pixel circuit electrically connected to the compensation circuit;
the pixel circuit is configured to receive a data compensation signal and control a current magnitude of a driving current flowing through a light-emitting element according to the data compensation signal, so as to apply an operating voltage to a first terminal of the light-emitting element;
the compensation circuit is configured to receive the operating voltage and a data voltage, and adjust the data compensation signal according to a difference between the operating v oltage and the data voltage;
the array substrate comprises a pixel array region, and the pixel array region comprises a plurality of sub-pixels arranged in an array; and
pixel circuits of the plurality of display driving circuits are respectively provided in the plurality of sub-pixels in the pixel array region of the array substrate, and compensation circuits of the display driving circuits are outside the pixel array region.

14. The display panel according to claim 13, further comprising a plurality of first transmitting lines and a plurality of second transmitting lines,
wherein each of the plurality of display driving circuits corresponds to one first transmitting line and one second transmitting line, the first transmitting line is connected between a pixel circuit and a compensation circuit of a corresponding display driving circuit so as to transmit the data compensation signal, and the second transmitting line is connected between the pixel circuit and the compensation circuit of the corresponding display driving circuit so as to transmit the operating voltage.

15. The display panel according to claim 13, further comprising a data driving circuit,
wherein the compensation circuit is provided in the data driving circuit.

16. The display panel according to claim 13, further comprising a data driving circuit,
wherein the array substrate further comprises a peripheral region outside the pixel array region, and the compensation circuit is provided in the peripheral region and is electrically connected to the data driving circuit.

17. A display device, comprising the display panel according to claim 13.

18. A method of driving a display driving circuit, wherein the display driving circuit comprises a compensation circuit and at least one pixel circuit electrically connected to the compensation circuit;
the pixel circuit is configured to receive a data compensation signal and control a current magnitude of a driving current flowing through a light-emitting element according to the data compensation signal, so as to apply an operating voltage to a first terminal of the light-emitting element and,
the compensation circuit is configured to receive the operating voltage and a data voltage, and adjust the data compensation signal according to a different between the operating voltage and the data voltage; and
the method comprises:
controlling the current magnitude of the driving current flowing through the light-emitting element according to the data compensation signal, so as to apply the operating voltage to the first terminal of the light-emitting element; and
receiving the data voltage and adjusting the data compensation signal according to the difference between the operating voltage and the data voltage.

19. The method according to claim 18, wherein receiving the data voltage and adjusting the data compensation signal according to the difference between the operating voltage and the data voltage comprises:
receiving the data voltage and adjusting the data compensation signal according to the difference between the operating voltage and the data voltage, so as to allow the operating voltage to be equal to the data voltage.
